(19) United States
(12) Patent Application Publication
(10) Pub. No.: US 2026/0311627 A1
(43) Pub. Date: Oct. 8, 2026

(54) DISPLAY DEVICE AND CONTROL METHOD OF DISPLAY DEVICE

(71) Applicant: Guangzhou China Star Optoelectronics Semiconductor Display Technology Co., Ltd., Guangzhou (CN)

(72) Inventor: Junsheng LIU, Guangzhou (CN)

(73) Assignee: Guangzhou China Star Optoelectronics Semiconductor Display Technology Co., Ltd., Guangzhou (CN)

(21) Appl. No.: 19/253,861

(22) Filed: Jun. 29, 2025

(30) Foreign Application Priority Data
Apr. 3, 2025 (CN) 202510424831.X

(51) Int. Cl. G09G 3/20; G09G 3/36

(52) U.S. Cl. CPC G09G 3/2096; G09G 3/36; G09G 2320/0247; G09G 2320/103; G09G 2330/023

(57) ABSTRACT

The present disclosure provides a display device and a control method of the display device. The display device includes a main board and a display panel connected to the main board, and the display panel includes a timing controller. The timing controller is configured to: control the display panel to enter a power-saving mode. The main board is configured to: detect a number of consecutive frames that the display panel remains in the power-saving mode in response to display images being switched from static to dynamic; and send a first exit command to the timing controller in response to the number of the consecutive frames being even. The timing controller is further configured to: control the display panel to exit the power-saving mode in response to the first exit command.

### CROSS-REFERENCE TO RELATED APPLICATION

The application claims priority to and the benefit of Chinese Patent Application No. 202510424831.X, filed on Apr. 3, 2025, the disclosure of which is incorporated herein by reference in its entirety.

### TECHNICAL FIELD

The present disclosure relates to display technologies, and in particular, to a display device and a control method of the display device.

### BACKGROUND

When display images in a display panel are rendered static, the display panel can enter a power-saving mode. In the power-saving mode, contents in a system memory of a display device can be copied to a memory of the display panel, so that the display panel reads display data directly from its own memory to refresh the display images without loading the display data from the system memory, thus achieving a purpose of reducing power consumption. When the display images are switched from static to dynamic, the display panel needs to exit the power-saving mode. As the display panel randomly enters and exits the power-saving mode, there is a potential to cause an imbalance in polarities of the positive and negative frame data, and voltages applied to two ends of liquid crystal cannot be canceled out, resulting in a residual charge at the two ends of the liquid crystal. After a long period of accumulation, it may lead to a polarization of the liquid crystal, thus causing image flickering and affecting display performance.

### SUMMARY

Embodiments of the present disclosure provide a display device and a control method of the display device, which can prevent charge residue at the two ends of the liquid crystal, thereby avoiding image flickering due to the polarization of the liquid crystal caused by the residual charge, and improving the display performance.

In a first aspect, an embodiment of the present disclosure provides a display device, including a main board and a display panel connected to the main board, and the display panel including a timing controller. The timing controller is configured to: control the display panel to enter a power-saving mode. The main board is configured to: detect a number of consecutive frames that the display panel remains in the power-saving mode in response to display images being switched from static to dynamic; and send a first exit command to the timing controller in response to the number of the consecutive frames being even. The timing controller is further configured to: control the display panel to exit the power-saving mode in response to the first exit command.

In a second aspect, an embodiment of the present disclosure provides a control method of a display device. The display device includes a main board and a display panel connected to the main board, and the display panel includes a timing controller. The control method includes: the timing controller controlling the display panel to enter a power-saving mode; the main board detecting a number of consecutive frames that the display panel remains in the power-saving mode in response to display images being switched from static to dynamic, and sending a first exit command to the timing controller in response to the number of the consecutive frames being even; and the timing controller controlling the display panel to exit the power-saving mode in response to the first exit command.

### BRIEF DESCRIPTION OF THE DRAWINGS

FIG. 1 is a schematic diagram of a display device according to an embodiment of the present disclosure;

FIG. 2 is a schematic diagram of a display panel according to an embodiment of the present disclosure;

FIG. 3 is a schematic diagram of experimental results of a flicker time according to an embodiment of the present disclosure;

FIG. 4 is a flowchart of a control method of the display device according to an embodiment of the present disclosure;

FIG. 5 is a flowchart of another control method of the display device according to an embodiment of the present disclosure; and

FIG. 6 is a flowchart of a yet another control method of the display device according to an embodiment of the present disclosure.

### DETAILED DESCRIPTION

Technical solutions in the embodiments of the present disclosure will be described below in conjunction with drawings in the embodiments of the present disclosure. The described technical solutions are merely for explaining and illustrating the ideas of the present disclosure, and should not be construed as limiting the scope of protection of the present disclosure.

In addition, “plurality of” in the embodiments of the present disclosure refers to two or more. “First”, “second” and the like in the embodiments of the present disclosure are used to distinguish different technical features, and do not indicate any order, quantity, or importance.

The various embodiments provided in the present disclosure are similar, and features in different embodiments may be combined with each other.

The order of description of the following embodiments is not intended to limit the preferred order of the embodiments.

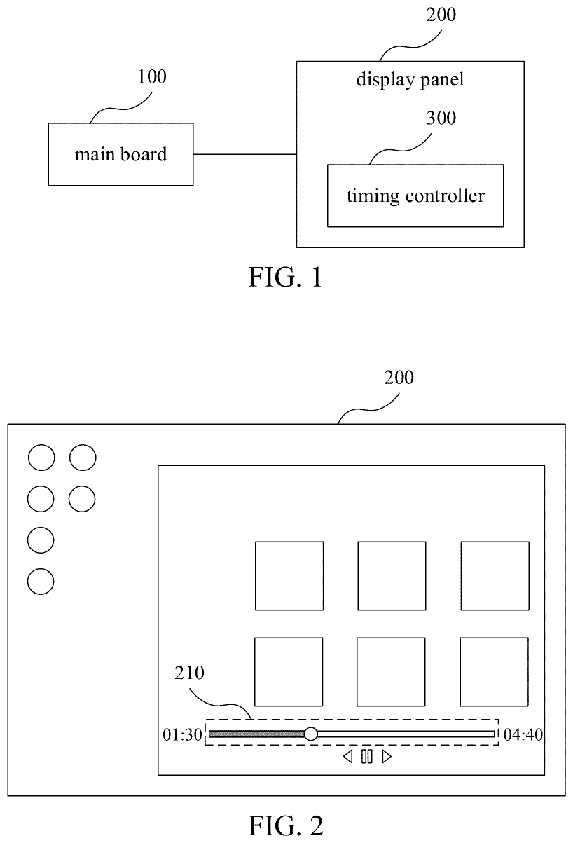

Referring to FIG. 1, FIG. 1 is a schematic diagram of a display device according to an embodiment of the present disclosure. As shown in FIG. 1, the display device includes: a main board 100 and a display panel 200 connected to the main board 100. The display panel 200 includes a timing controller (referred to as TCON) 300.

The timing controller 300 is configured to: control the display panel 200 to enter a power-saving mode.

The main board 100 is configured to: detect a number of consecutive frames that the display panel 200 remains in the power-saving mode in response to display images being switched from static to dynamic; and send a first exit command to the timing controller 300 in response to the number of the consecutive frames being even.

The timing controller 300 is further configured to: control the display panel 200 to exit the power-saving mode in response to the first exit command.

A specific mode of the power-saving mode is not limited in the embodiments of the present disclosure. In some embodiments, the power-saving mode includes a panel self-refreshing (referred to as PSR) mode. In the panel self-refreshing mode, contents in a system memory can be copied to a memory of the display panel, so that the display panel reads display data directly from its own memory to refresh the display images without loading the display data from the system memory. Of course, the power-saving mode may also include another mode, such as a low refresh rate (referred to as LRR) mode or a content adaptive brightness control (referred to as CABC) mode, etc. In the low refresh rate mode, the display panel reduces a refresh rate to save power. In the content adaptive brightness control mode, a backlight brightness of the display panel is dynamically adjusted by sensing a level of the brightness/darkness of the display images.

When the display images are static, for example, when the display images are switched from dynamic to static, the display panel 200 may be controlled to enter the power-saving mode by the timing controller 300. In the embodiments of the present disclosure, the display images may be continuously detected by the main board 100, and when the main board 100 detects that the display images are static, the main board 100 may send an entry command to the timing controller 300, so that the timing controller 300 controls the display panel 200 to enter the power-saving mode according to the entry command. It should be understood that the static of the display images means that the content of the display images has not changed, and the dynamic of the display images means that the content of the display images has changed.

The main board 100 continuously detects the display images, and in response to the display images being switched from static to dynamic, the main board 100 detects the number of the consecutive frames that the display panel 200 remains in the power-saving mode. In some embodiments, the main board 100 determines the number of the consecutive frames that the display panel 200 remains in the power-saving mode based on a first moment, a second moment, and a duration of a single frame of the display images. The first moment may be a moment when the main board 100 detects that the display images are switched from dynamic to static, the second moment may be a moment when the main board 100 detects that the display images are switched from static to dynamic, and the display images are static between the first moment and the second moment. The main board 100 may determine the number of the consecutive frames that the display panel 200 remains in the power-saving mode based on a duration between the first moment and the second moment, as well as on the duration of the single frame of the display images. For example, the number of the consecutive frames=(the second moment−the first moment)/the duration of the single frame.

Since the positive and negative frame voltages of the data output cannot be canceled out when the time in the power-saving mode is an odd number of frames, the liquid crystal may be polarized and thus cause flickering after a long period of accumulation. Therefore, when the main board 100 detects that the display images are switched from static to dynamic, instead of immediately controlling the display panel 200 to exit the power-saving mode, the main board 100 determines whether the number of the consecutive frames that the display panel 200 remains in the power-saving mode is even, and controls the display panel 200 to exit the power-saving mode based on the determination.

If the number of the consecutive frames that the display panel 200 remains in the power-saving mode is even, the display panel 200 can currently exit the power-saving mode without causing charge residue. In response to the number of the consecutive frames that the display panel 200 remains in the power-saving mode being even, the main board 100 sends the first exit command to the timing controller 300, and the timing controller 300 controls the display panel 200 to exit the power-saving mode in response to the first exit command.

If the number of the consecutive frames that the display panel 200 remains in the power-saving mode is odd, the display panel 200 may not currently exit the power-saving mode because if the display panel 200 currently exits the power-saving mode, it will result in charge residue. In some embodiments, in response to the number of the consecutive frames that the display panel 200 remains in the power-saving mode being odd, the main board 100 may continuously detect the number of the consecutive frames that the display panel 200 remains in the power-saving mode, and in response to the number of the consecutive frames that the display panel 200 remains in the power-saving mode being even, the main board 100 sends the first exit command to the timing controller 300. In other embodiments, the main board 100 is further configured to: send the first exit command to the timing controller 300 after a first number of frames in response to the number of the consecutive frames that the display panel 200 remains in the power-saving mode being odd. In other embodiments, the main board 100 is further configured to: send a second exit command to the timing controller 300 in response to the number of the consecutive frames that the display panel 200 remains in the power-saving mode being odd; and the timing controller 300 is further configured to: control the display panel 200 to exit the power-saving mode after a first number of frames in response to the second exit command.

The first number of frames is odd. A specific number of the first number of frames is not limited in the embodiments of the present disclosure, for example, the first number of frames may be 1 frame, 3 frames, or 5 frames, etc., and the first number of frames may be set flexibly in accordance with the requirements in the practical applications. If the number of the consecutive frames that the display panel 200 remains in the power-saving mode is odd, the first exit command may be sent by the main board 100 to the timing controller 300 after waiting for the first number of frames, and the timing controller 300 controls the display panel 200 to exit the power-saving mode in response to the first exit command; alternatively, the second exit command may be sent by the main board 100 to the timing controller 300, and the timing controller 300 controls the display panel 200 to exit the power-saving mode after waiting for the first number of frames in response to the second exit command. The embodiments of the present disclosure ensure that the number of the consecutive frames that the display panel 200 remains in the power-saving mode is even when the display panel 200 exits the power-saving mode, thereby avoiding charge residue.

The first exit command and the second exit command are different. The timing controller 300, in response to the first exit command, immediately controls the display panel 200 to exit the power-saving mode; and the timing controller 300, in response to the second exit command, controls the display panel 200 to exit the power-saving mode after the first number of frames. A specific setting method of the first exit command and the second exit command is not limited in the embodiments of the present disclosure, and the specific setting method may be set flexibly in accordance with the requirements in the practical applications. For example, the first exit command is 00 and the second exit command is 01; or the first exit command is 01 and the second exit command is 00.

In conclusion, a display device, provided by the embodiments of the present disclosure, includes a main board and a display panel connected to the main board. The display panel includes a timing controller. The timing controller is configured to: control the display panel to enter a power-saving mode. The main board is configured to: detect a number of consecutive frames that the display panel remains in the power-saving mode in response to display images being switched from static to dynamic, and send a first exit command to the timing controller in response to the number of the consecutive frames being even. The timing controller is further configured to: control the display panel to exit the power-saving mode in response to the first exit command. In the embodiments of the present disclosure, after the display panel enters the power-saving mode, if it is detected that the display images are switched from static to dynamic, the display panel is controlled to exit the power-saving mode when the number of the consecutive frames that the display panel remains in the power-saving mode is even, so as to ensure that the polarities of the positive and negative frames are eliminated one by one to prevent charge residue at the two ends of the liquid crystal, thereby avoiding image flickering due to the polarization of the liquid crystal caused by the residual charge, which improves the display performance and extends the service life of the display panel.

In some embodiments, the main board 100 is further configured to: send a first entry command to the timing controller 300 after a second number of frames in response to the display images being switched from dynamic to static; and the timing controller 300 is further configured to: control the display panel 200 to enter the power-saving mode in response to the first entry command.

In other embodiments, the main board 100 is further configured to: send a second entry command to the timing controller 300 in response to the display images being switched from dynamic to static; and the timing controller 300 is further configured to: control the display panel 200 to enter the power-saving mode after a second number of frames in response to the second entry command.

The main board 100 continuously detects the display images, and if it is detected that the display images are switched from dynamic to static, the display panel 200 is controlled to enter the power-saving mode. In the embodiments of the present disclosure, when the main board 100 detects that the display images are switched from dynamic to static, instead of controlling the display panel 200 to enter the power-saving mode immediately, the display panel 200 is controlled to enter the power-saving mode after delaying the second number of frames. A specific number of the second number of frames is not limited in the embodiments of the present disclosure, the second number of frames may be any number of frames, and the second number of frames may be set flexibly in accordance with the requirements in the practical applications. For example, the second number of frames may be 1 frame, 2 frames, 3 frames, or 4 frames, etc. In some embodiments, the second number of frames is negatively correlated with an anti-polarization capability of the display panel. The stronger the anti-polarization capability of the display panel, the smaller the second number of frames; and the weaker the anti-polarization capability of the display panel, the larger the second number of frames. Of course, the second number of frames may also be related to the design characteristics of the display panel, etc., and the second number of frames may be preset in accordance with the test situation of the display panel in the practical applications.

If the display images are switched from dynamic to static, the first entry command may be sent to the timing controller 300 by the main board 100 after waiting for the second number of frames, and the timing controller 300, in response to the first entry command, controls the display panel 200 to enter the power-saving mode; alternatively, the second entry command may be sent to the timing controller 300 by the main board 100, and the timing controller 300, in response to the second entry command, controls the display panel 200 to enter the power-saving mode after waiting for the second number of frames. The embodiments of the present disclosure delay the time when the display panel 200 enters the power-saving mode, which reduces the frequency of static electricity accumulation, so that even though image flickering may still occur due to the residual charge, the probability of the occurrence of flickering during terminal application is reduced due to the time delay.

The first entry command and the second entry command are different. The timing controller 300, in response to the first entry command, immediately controls the display panel 200 to enter the power-saving mode; and the timing controller 300, in response to the second entry command, controls the display panel 200 to enter the power-saving mode after the second number of frames. A specific setting method of the first entry command and the second entry command is not limited in the embodiments of the present disclosure, and the specific setting method may be set flexibly in accordance with the requirements in the practical applications. For example, the first entry command is 11 and the second entry command is 10; or the first entry command is 10 and the second entry command is 11.

Exemplarily, the display panel 200 enters the power-saving mode at the 1st frame and continues for 5 frames before exiting the power-saving mode; enters the power-saving mode at the 8th frame and continues for 6 frames before exiting the power-saving mode; and enters the power-saving mode at the 16th frame and continues for 3 frames before exiting the power-saving mode. The display panel enters and exits the power-saving mode three times during a period of 18 frames. If, based on the technical solutions provided in the embodiments of the present disclosure, the display panel 200 enters the power-saving mode after each delaying the second number of frames, such as entering the power-saving mode after delaying 6 frames, the display panel 200 enters the power-saving mode at the 7th frame and continues for 5 frames before exiting the power-saving mode; enters the power-saving mode at the 14th frame and continues for 6 frames before exiting the power-saving mode; and enters the power-saving mode at the 22nd frame and continues for 3 frames before exiting the power-saving mode. During a same period of 18 frames, the display panel enters the power-saving mode only two times, which reduces the frequency of static electricity accumulation.

In conclusion, a display device provided by the embodiments of the present disclosure includes a main board and a display panel connected to the main board. The display panel includes a timing controller. The display panel is controlled to enter the power-saving mode after delaying a certain number of frames when the main board detects that the display images are switched from dynamic to static. The embodiments of the present disclosure delay the time when the display panel enters the power-saving mode, which reduces the frequency of static electricity accumulation, so that even though image flickering may still occur due to the residual charge, the probability of the occurrence of flickering during terminal application is reduced due to the time delay, thereby improving the display performance and extending the service life of the display panel.

Exemplarily, as shown in FIG. 2, when an audio is played, only a progress bar 210 changes once per second in the display images of the display panel 200. The display images are static and non-refreshing at a millisecond level, so that the display panel 200 is controlled to enter the power-saving mode after delaying 8 frames when the main board detects that the display images are static, and the display panel 200 is controlled to exit the power-saving mode when the progress bar 210 changes for every second. After conducting multiple experiments, as shown in FIG. 3, in a case where the display panel 200 immediately enters the power-saving mode, the display panel 200 begins to flicker after playing audios continuously for 1 to 2 hours; and in a case where the display panel 200 enters the power-saving mode after delaying for 8 frames, the display panel 200 does not flicker even after playing continuously for 6 hours. It can be seen that the embodiments of the present disclosure improve the display performance.

It should be understood that the technical solutions provided by the embodiments of the present disclosure may be used independently or in combination. For example, the display panel may be controlled, only when the display panel exits the power-saving mode, to exit the power-saving mode when the number of the consecutive frames that the display panel remains in the power-saving mode is even; or the display panel may be controlled, only when the display panel enters the power-saving mode, to enter the power-saving mode after delaying a certain number of frames; or the display panel may be controlled, when the display panel enters the power-saving mode, to enter the power-saving mode after delaying a certain number of frames, and be controlled, when the display panel exits the power-saving mode, to exit the power-saving mode when the number of the consecutive frames that the display panel remains in the power-saving mode is even.

In some embodiments, the display device provided by the embodiments of the present disclosure includes, but is not limited to, a AMOLED (Active Matrix Organic Light Emitting Diode) display, a Micro LED (Micro Light Emitting Diode) display, a Mini Led (Miniature Light Emitting Diode) display, and the like.

The embodiments of the present disclosure further provide a control method of the display device.

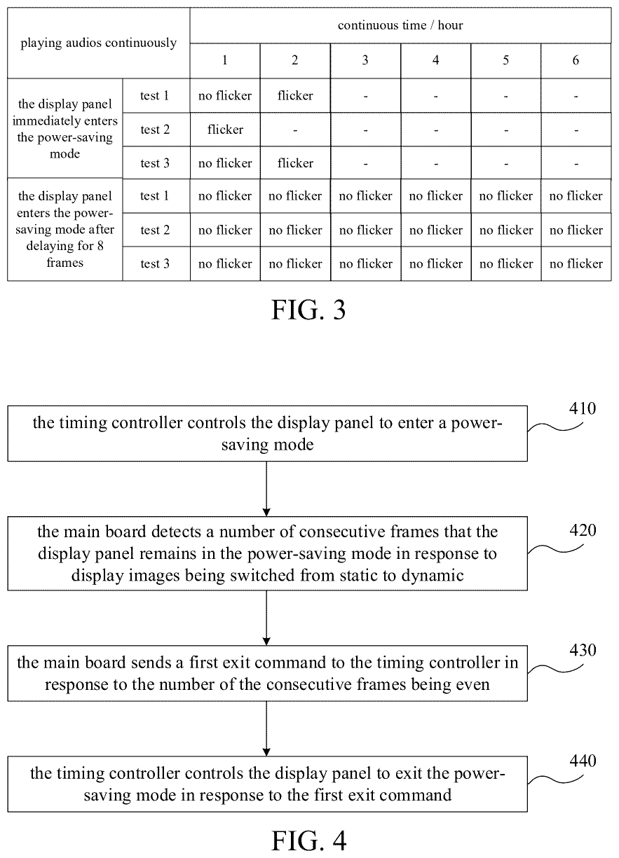

Referring to FIG. 4, FIG. 4 is a flowchart of a control method of the display device according to an embodiment of the present disclosure. The display device includes the main board and the display panel connected to the main board. The display panel includes the timing controller. As shown in FIG. 4, the control method may include the following steps:
step 410: the timing controller controls the display panel to enter a power-saving mode;
step 420: the main board detects a number of consecutive frames that the display panel remains in the power-saving mode in response to display images being switched from static to dynamic;
step 430: the main board sends a first exit command to the timing controller in response to the number of the consecutive frames being even; and
step 440: the timing controller controls the display panel to exit the power-saving mode in response to the first exit command.

In some embodiments, after the aforementioned step 420, the control method further includes: the main board sending the first exit command to the timing controller after a first number of frames in response to the number of the consecutive frames being odd; and the timing controller controlling the display panel to exit the power-saving mode in response to the first exit command. The first number of frames is odd.

In some embodiments, after the aforementioned step 420, the control method further includes: the main board sending a second exit command to the timing controller in response to the number of the consecutive frames being odd; the timing controller controlling the display panel to exit the power-saving mode after a first number of frames in response to the second exit command. Among them, the first number of frames is odd.

In some embodiments, the aforementioned step 420 includes: the main board determining the number of the consecutive frames based on a first moment, a second moment, and a duration of a single frame of the display images. The first moment is a moment when the main board detects that the display images are switched from dynamic to static, and the second moment is a moment when the main board detects that the display images are switched from static to dynamic.

In some embodiments, the main board determining the number of the consecutive frames based on a first moment, a second moment, and a duration of a single frame of the display images includes: the main board determining the number of the consecutive frames based on a duration between the first moment and the second moment, as well as on the duration of the single frame of the display images.

In some embodiments, the power-saving mode includes a panel self-refreshing mode.

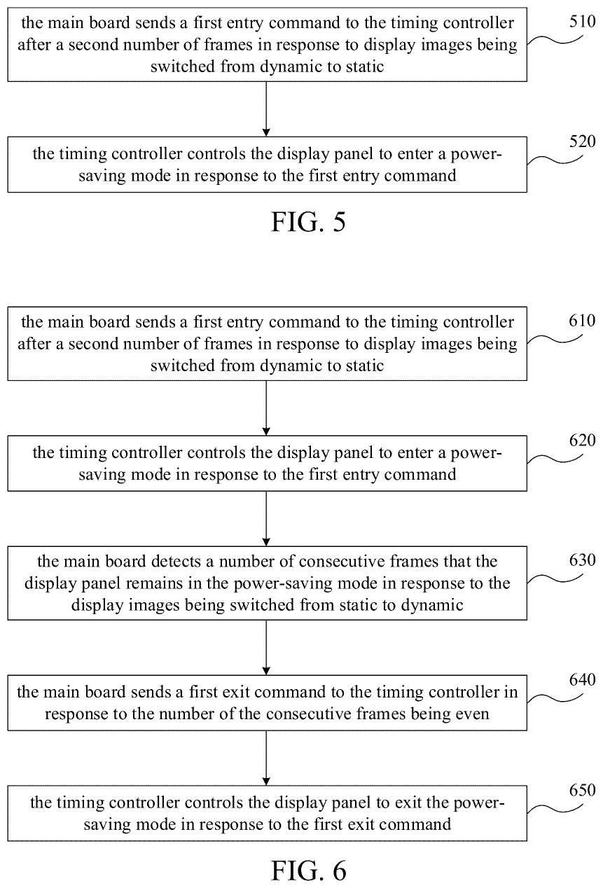

Referring to FIG. 5, FIG. 5 is a flowchart of another control method of the display device according to an embodiment of the present disclosure. The display device includes the main board and the display panel connected to the main board. The display panel includes the timing controller. As shown in FIG. 5, the control method may include the following steps:
step 510: the main board sends a first entry command to the timing controller after a second number of frames in response to display images being switched from dynamic to static; and
step 520: the timing controller controls the display panel to enter a power-saving mode in response to the first entry command.

In some embodiments, the control method further includes: the main board sending a second entry command to the timing controller in response to the display images being switched from dynamic to static; and the timing controller controlling the display panel to enter the power-saving mode after a second number of frames in response to the second entry command.

In some embodiments, the second number of frames is negatively correlated with an anti-polarization capability of the display panel.

In some embodiments, the power-saving mode includes a panel self-refreshing mode.

It should be understood that the control methods provided by the embodiments of the present disclosure may be used independently or in combination. For example, the display panel may be controlled, only when the display panel exits the power-saving mode, to exit the power-saving mode when the number of the consecutive frames that the display panel remains in the power-saving mode is even; or the display panel may be controlled, only when the display panel enters the power-saving mode, to enter the power-saving mode after delaying a certain number of frames; or the display panel may be controlled, when the display panel enters the power-saving mode, to enter the power-saving mode after delaying a certain number of frames, and be controlled, when the display panel exits the power-saving mode, to exit the power-saving mode when the number of the consecutive frames that the display panel remains in the power-saving mode is even.

An example will be used below to explain the combination of the control methods.

Referring to FIG. 6, FIG. 6 is a flowchart of a yet another control method of the display device according to an embodiment of the present disclosure. The display device includes the main board and the display panel connected to the main board. The display panel includes the timing controller. As shown in FIG. 6, the control method may include the following steps:
step 610: the main board sends a first entry command to the timing controller after a second number of frames in response to display images being switched from dynamic to static;
step 620: the timing controller controls the display panel to enter a power-saving mode in response to the first entry command;
step 630: the main board detects a number of consecutive frames that the display panel remains in the power-saving mode in response to the display images being switched from static to dynamic;
step 640: the main board sends a first exit command to the timing controller in response to the number of the consecutive frames being even; and
step 650: the timing controller controls the display panel to exit the power-saving mode in response to the first exit command.

For a specific description of the steps in the control methods of the display device and corresponding beneficial effects, please refer to the detailed description of the display device above, which will not be repeated here.

The present disclosure has been described in detail with reference to a display device and a control method of the display device provided in the embodiments of the present disclosure. Specific examples are used herein to illustrate the principles and embodiments of the present disclosure. The description of the above embodiments is merely intended to help understand the technical solutions and the core idea of the present disclosure. At the same time, those skilled in the art may make modifications to the specific implementation modes and applying ranges based on concepts disclosed herein. In summary, the content of the description should not be construed as limiting the scope of the present disclosure.

1. A display device, comprising a main board and a display panel connected to the main board, and the display panel comprising a timing controller;
wherein the timing controller is configured to: control the display panel to enter a power-saving mode;
wherein the main board is configured to: detect a number of consecutive frames that the display panel remains in the power-saving mode in response to display images being switched from static to dynamic; and send a first exit command to the timing controller in response to the number of the consecutive frames being even;
wherein the timing controller is further configured to: control the display panel to exit the power-saving mode in response to the first exit command;
wherein the main board is further configured to: send a first entry command to the timing controller after a second number of frames in response to the display images being switched from dynamic to static; the timing controller is further configured to: control the display panel to enter the power-saving mode in response to the first entry command; and the second number of frames is negatively correlated with an anti-polarization capability of the display panel; or
wherein the main board is further configured to: send a second entry command to the timing controller in response to the display images being switched from dynamic to static; the timing controller is further configured to: control the display panel to enter the power-saving mode after a second number of frames in response to the second entry command; and the second number of frames is negatively correlated with an anti-polarization capability of the display panel.

2. The display device according to claim 1,
wherein the main board is further configured to: send the first exit command to the timing controller after a first number of frames in response to the number of the consecutive frames being odd, and the first number of frames is odd.

3. The display device according to claim 1,
wherein the main board is further configured to: send a second exit command to the timing controller in response to the number of the consecutive frames being odd;
wherein the timing controller is further configured to: control the display panel to exit the power-saving mode after a first number of frames in response to the second exit command, and the first number of frames is odd.

4. The display device according to claim 1,
wherein the main board is configured to: determine the number of the consecutive frames based on a first moment, a second moment, and a duration of a single frame of the display images; the first moment is a moment when the main board detects that the display images are switched from dynamic to static; and the second moment is a moment when the main board detects that the display images are switched from static to dynamic.

5. The display device according to claim 4,
wherein the main board is configured to: determine the number of the consecutive frames based on a duration between the first moment and the second moment, as well as on the duration of the single frame of the display images.

6-9. (canceled)

10. The display device according to claim 1, wherein the power-saving mode comprises a panel self-refreshing mode.

11. A control method of a display device, wherein the display device comprises a main board and a display panel connected to the main board, and the display panel comprises a timing controller; and the control method comprises:
controlling, by the timing controller, the display panel to enter a power-saving mode;
detecting, by the main board, a number of consecutive frames that the display panel remains in the power-saving mode in response to display images being switched from static to dynamic; and sending a first exit command to the timing controller in response to the number of the consecutive frames being even; and
controlling, by the timing controller, the display panel to exit the power-saving mode in response to the first exit command;
wherein the control method further comprises: sending, by the main board, a first entry command to the timing controller after a second number of frames in response to the display images being switched from dynamic to static; controlling, by the timing controller, the display panel to enter the power-saving mode comprises: controlling, by the timing controller, the display panel to enter the power-saving mode in response to the first entry command; and the second number of frames is negatively correlated with an anti-polarization capability of the display panel; or
wherein the control method further comprises: sending, by the main board, a second entry command to the timing controller in response to the display images being switched from dynamic to static; controlling, by the timing controller, the display panel to enter the power-saving mode comprises: controlling, by the timing controller, the display panel to enter the power-saving mode after a second number of frames in response to the second entry command; and the second number of frames is negatively correlated with an anti-polarization capability of the display panel.

12. The control method of the display device according to claim 11, wherein after detecting, by the main board, the number of the consecutive frames that the display panel remains in the power-saving mode in response to the display images being switched from static to dynamic, the control method further comprises:
sending, by the main board, the first exit command to the timing controller after a first number of frames in response to the number of the consecutive frames being odd, and the first number of frames is odd.

13. The control method of the display device according to claim 11, wherein after detecting, by the main board, the number of the consecutive frames that the display panel remains in the power-saving mode in response to the display images being switched from static to dynamic, the control method further comprises:
sending, by the main board, a second exit command to the timing controller in response to the number of the consecutive frames being odd;
controlling, by the timing controller, the display panel to exit the power-saving mode after a first number of frames in response to the second exit command, and the first number of frames is odd.

14. The control method of the display device according to claim 11, wherein detecting, by the main board, the number of the consecutive frames that the display panel remains in the power-saving mode comprises:
determining, by the main board, the number of the consecutive frames based on a first moment, a second moment, and a duration of a single frame of the display images; the first moment is a moment when the main board detects that the display images are switched from dynamic to static; and the second moment is a moment when the main board detects that the display images are switched from static to dynamic.

15. The control method of the display device according to claim 14, wherein determining, by the main board, the number of the consecutive frames based on a first moment, a second moment, and a duration of a single frame of the display images comprises:
determining, by the main board, the number of the consecutive frames based on a duration between the first moment and the second moment, as well as on the duration of the single frame of the display images.

16-19. (canceled)

20. The control method of the display device according to claim 11, wherein the power-saving mode comprises a panel self-refreshing mode.
